(19) United States
(12) Patent Application Publication
(10) Pub. No.: US 2022/0276596 A1
(43) Pub. Date: Sep. 1, 2022

(54) FIXING DEVICE AND IMAGE FORMING APPARATUS

(71) Applicant: KYOCERA Document Solutions Inc., Osaka (JP)

(72) Inventors: Takashi EIKI, Osaka-shi (JP); Akihiro KONDO, Osaka-shi (JP); Ryohei TOKUNAGA, Osaka-shi (JP); Yuta KITABAYASHI, Osaka-shi (JP); Hiroki KAWASAKI, Osaka-shi (JP); Shunsaku FUJII, Osaka-shi (JP); Tei TO, Osaka-shi (JP); Rina KIKUGAWA, Osaka-shi (JP)

(73) Assignee: KYOCERA Document Solutions Inc., Osaka (JP)

(21) Appl. No.: 17/652,590

(22) Filed: Feb. 25, 2022

(30) Foreign Application Priority Data
Feb. 26, 2021 (JP) 2021-030767

(51) Int. Cl. G03G 15/20

(52) U.S. Cl. CPC G03G 15/2053; G03G 15/2064

(57) ABSTRACT

A heater includes a fixing device including a heater substrate, electrodes, a heating element, and a heat conducting member. The heating element is disposed on a facing surface of the heater substrate that is to face a sheet, and includes a plurality of heating element pieces arranged in a line in a main scanning direction of the sheet with a gap therebetween. The heat conducting member stores heat generated from the heating element and radiates the heat toward the sheet passing over the gap.

### INCORPORATION BY REFERENCE

The present application claims priority under 35 U.S.C. § 119 to Japanese Patent Application No. 2021-030767, filed on Feb. 26, 2021. The contents of this application are incorporated herein by reference in their entirety.

### BACKGROUND

The present disclosure relates to a fixing device and an image forming apparatus. There is a fixing device including a cylindrical film, a pressure roller, a heater in contact with the inner surface of the film, and a metal plate serving as a heat conducting member in contact with the heater.

### SUMMARY

A fixing device according to an aspect of the present disclosure includes a heater that heats a toner image transferred to a sheet for fixing the toner image to the sheet. The heater includes a heater substrate having a facing surface that is to face the sheet and an opposite surface opposite to the facing surface, a heating element, and a heat conducting member. The heating element is disposed on the facing surface of the heater substrate, and includes a plurality of heating element pieces arranged in a line in a main scanning direction of the sheet with a gap therebetween. The heat conducting member stores heat generated from the heating element, and radiates the heat toward the sheet passing over the gap.

### BRIEF DESCRIPTION OF THE DRAWINGS

FIG. 1 is a diagram illustrating a multifunction peripheral including a fixing device according to an embodiment of the present disclosure.

FIG. 2 is a block diagram of a configuration of an image forming apparatus including the fixing device according to the embodiment.

FIG. 3 is a cross-sectional view of the fixing device according to the embodiment.

FIGS. 4A and 4B are diagrams illustrating a configuration of a heater of the fixing device according to the embodiment.

FIGS. 5A and 5B are a cross-sectional view and a side view of the heater of the fixing device according to the embodiment, respectively.

FIGS. 6A and 6B are plan views of the heater of the fixing device according to the embodiment.

FIG. 7 is a diagram illustrating a temperature distribution of the heater of the fixing device according to the embodiment.

FIG. 8 is a graph representation showing a relationship between the amount of overlap between a heat conducting member and corresponding heating element pieces and temperature difference between a gap and the heating element pieces in the heater of the fixing device according to the embodiment.

### DETAILED DESCRIPTION

The following describes an embodiment of the present disclosure with reference to the accompanying drawings. Note that elements that are the same or equivalent are indicated by the same reference signs in the drawings and description thereof is not repeated. In the drawings, an X axis, a Y axis, and a Z axis that are perpendicular to one another are indicated as appropriate. The Z axis is parallel to the vertical direction, and the X axis and the Y axis are parallel to a horizontal plane.

The Z-axis direction may be referred to as “main scanning direction” in the present embodiment. Also, the Y-axis direction may be referred to as “sub-scanning direction”. The X-axis direction may be referred to as “direction perpendicular to the main scanning direction and the sub-scanning direction”.

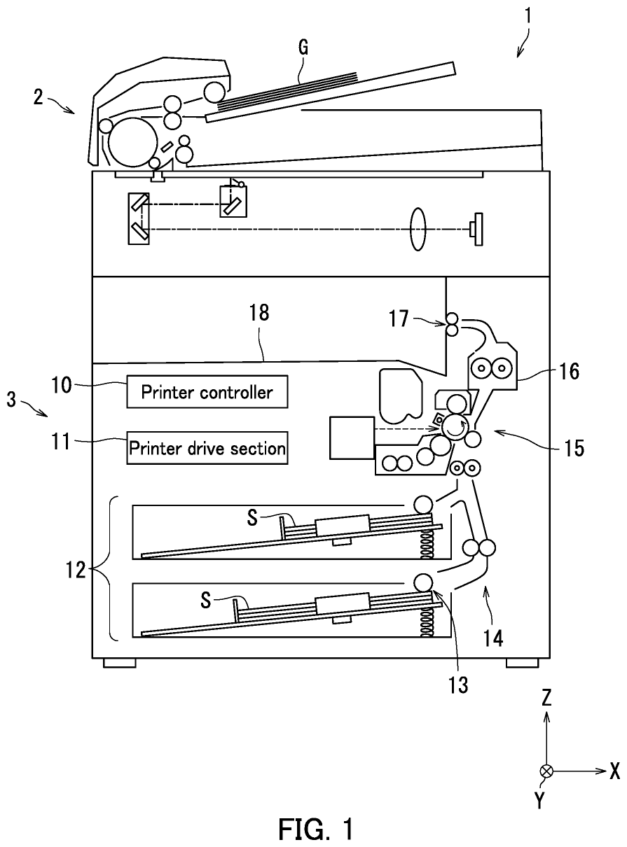

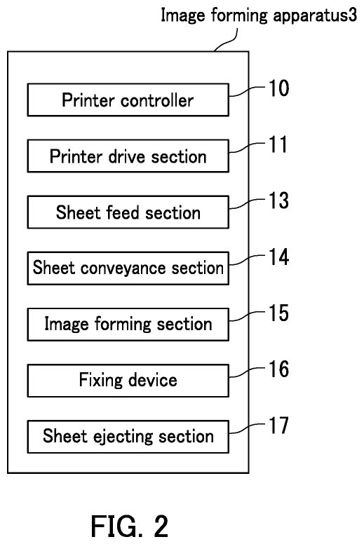

The configuration of a multifunction peripheral 1 will be described with reference to FIG. 1. FIG. 1 is a diagram illustrating the multifunction peripheral 1 including a fixing device 16 according to the present embodiment. The configuration of an image forming apparatus 3 including the fixing device 16 in the present embodiment will be also described with reference to FIG. 2. FIG. 2 is a block diagram of the configuration of the image forming apparatus 3 including the fixing device 16 in the present embodiment.

As illustrated in FIG. 1, the multifunction peripheral 1 includes a document reading device 2 and an image forming apparatus 3. The multifunction peripheral 1 has functions of a scanner, a copier, a printer, and a facsimile machine, and an additional function, for example.

The document reading device 2 includes a document feed tray, a document feed section, a document conveyance section, a document reading section, an optical member, a document ejecting section, and a document exit tray, for example.

The image forming apparatus 3 includes a printer controller 10, a printer drive section 11, sheet trays 12, sheet feed sections 13, a sheet conveyance section 14, an image forming section 15, a fixing section 16 (fixing device 16), a sheet ejecting section 17, and a sheet exit tray 18. The fixing section 16 may be referred to as fixing device 16.

The printer controller 10 controls operation of each element of the image forming apparatus 3. The printer controller 10 may function as a controller that controls operation of each element of the multifunction peripheral 1. Specific examples of the printer controller 10 includes a central processing unit (CPU), a micro-processing unit (MPU), and an application specific integrated circuit (ASIC).

The printer drive section 11 drives each element of the image forming apparatus 3. The printer drive section 11 may be a drive section that drives each element of the multifunction peripheral 1. Specific examples of the printer drive section 11 include an electric motor, an electromagnetic solenoid, a hydraulic cylinder, and a pneumatic cylinder.

Sheets S are stacked on each sheet tray 12. The sheets S each are an example of a recording medium. The sheet tray 12 may include a tray and a lifting member. The sheet feed sections 13 each pick up the sheets S stacked on the sheet tray 12 one at a time for feeding. The sheet feed sections 13 are pickup rollers, for example.

The sheet conveyance section 14 conveys each sheet S fed from the sheet tray 12. The sheet conveyance section 14 forms a conveyance path. The conveyance path extends from each sheet tray 12 as a starting point to the sheet ejecting section 17 via the image forming section 15 and the fixing section 16. The sheet conveyance section 14 may include conveyance rollers and a registration roller along the conveyance path.

The conveyance rollers may be disposed along the conveyance path to convey the sheet S. The registration roller adjusts timing of conveyance of the sheet S to the image forming section 15. The sheet conveyance section 14 conveys the sheet S from the sheet tray 12 to the sheet ejecting section 17 via the image forming section 15 and the fixing section 16.

The image forming section 15 electrographically forms a non-illustrated toner image on the sheet S based on document image data. The document image data represents an image of a document G, for example.

The fixing section 16 applies heat and pressure to the toner image developed on the sheet S to fix the toner image to the sheet S.

The sheet ejecting section 17 ejects the sheet S out of the casing of the multifunction peripheral 1 (image forming apparatus 3). The sheet ejecting section 17 is an ejection roller, for example.

The sheets S ejected by the sheet ejecting section 17 are stacked on the sheet exit tray 18.

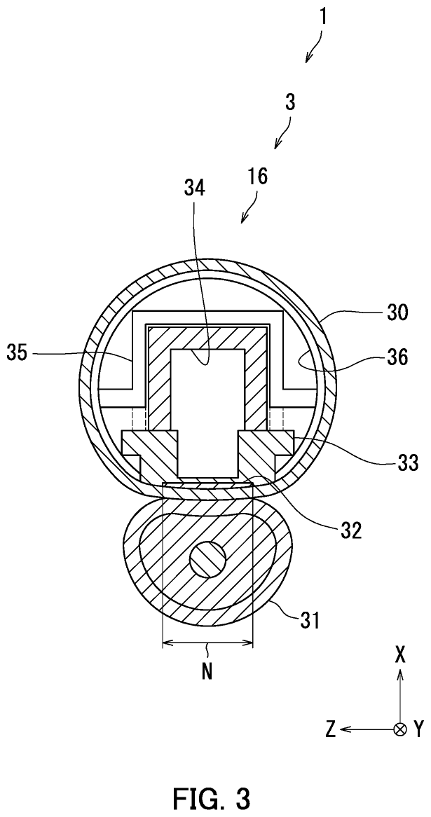

The configuration of the fixing device 16 according to the present embodiment will be described next in detail with reference to FIG. 3. FIG. 3 is a cross-sectional view of the fixing device 16 according to the present embodiment.

As illustrated in FIG. 3, the fixing device 16 includes a fixing belt 30, a pressure member 31, a heater 32, a heater holding member 33, a frame stay metal plate 34, a frame stay metal plate holder 35, and a fixing belt holder 36.

The fixing belt 30 heats the sheet S (FIG. 1), to which the toner image formed in the image forming section 15 illustrated in FIG. 1 has been transferred and which has been conveyed to the fixing device 16, to fix the toner image to the sheet S.

The fixing belt 30 illustrated in FIG. 3 is an endless belt. The fixing belt 30 has a substantially cylindrical shape. The fixing belt 30 is flexible.

The fixing belt 30 includes a plurality of layers. For example, the fixing belt 30 includes a polyimide layer containing polyimide, an elastic layer containing an elastic material such as silicone rubber, and a release layer. The release layer serves as an outermost layer formed on the outer circumferential surface of the polyimide layer. The release layer is a heat resistant film made from fluororesin, for example.

While being pressed against (in contact with) the fixing belt 30, the pressure member 31 rotates to rotate the fixing belt 30. The pressure member 31 has a substantially columnar shape, and is disposed opposite to the fixing belt 30. The pressure member 31 is a pressure roller, for example.

The pressure member 31 includes a columnar metal core, a cylindrical elastic layer, and a release layer. The elastic layer is formed on the metal core. The release layer is formed to cover the surface of the elastic layer.

The metal core is made from stainless steel or aluminum, for example. The elastic layer is elastic and is made from for example silicone rubber. The release layer is made from fluororesin, for example.

The heater 32 is connected to a non-illustrated power source and generates heat. The heater 32 heats the fixing belt 30. The heater 32 is disposed opposite to the inner circumferential surface of the fixing belt 30.

The heater 32 is a surface heater or a heater with a thin and narrow plate shape, for example. For example, the heater 32 is a ceramic heater and includes a ceramic substrate and a resistive heating element. The heater 32 has a thickness of 1 mm, for example. The heater 32 receives pressure from the pressure member 31 via the fixing belt 30.

As a result of the pressure member 31 being pressed to the fixing belt 30, a nip part N is formed at a contact part between the fixing belt 30 and the pressure member 31. As a result of the pressure member 31 being pressed to the fixing belt 30, the heater 32 is pressed against the inner circumferential surface of the fixing belt 30. As such, the fixing belt 30 is heated by the heater 32 to fix the toner image formed on the sheet S (FIG. 1) to the sheet S when the sheet S passes through the nip part N.

The heater holding member 33 guides the fixing belt 30 in a rotatable manner, and holds the heater 32 that heats the fixing belt 30.

The frame stay metal plate 34 reinforces the heater holding member 33. The frame stay metal plate 34 is a metal-made slender frame stay member, for example. The frame stay metal plate 34 may have an angular U shape, a U shape, or a V shape.

The frame stay metal plate holder 35 holds the frame stay metal plate 34 so as to fix the frame stay metal plate 34 to the heater holding member 33.

The fixing belt holder 36 guides the fixing belt 30 in a rotatable manner.

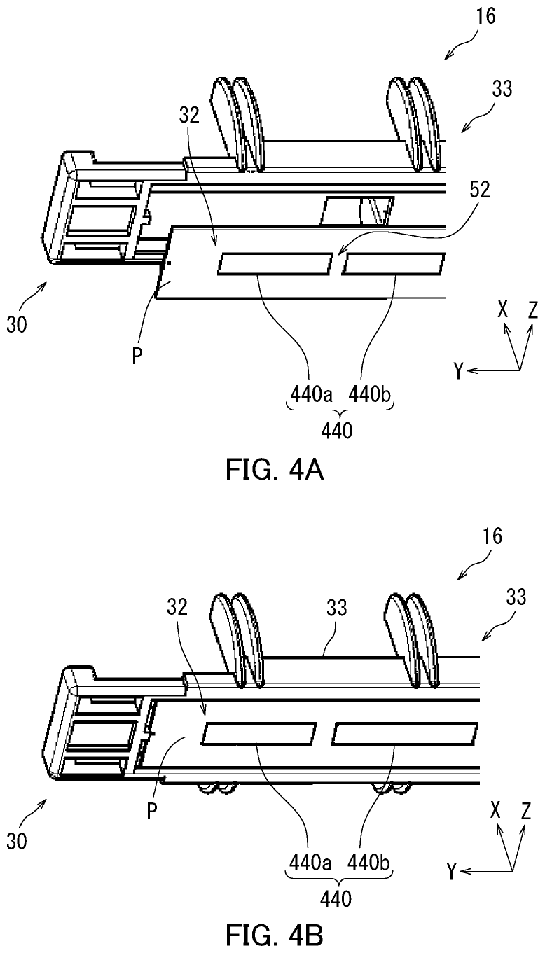

A configuration of the heater 32 of the fixing device 16 will be described next with reference to FIGS. 4A to 6B. FIGS. 4A to 6B are diagrams illustrating the configuration of the heater 32 of the fixing device 16 according to the present embodiment.

FIG. 4A is a perspective view of the heater 32 and the heater holding member 33 as viewed obliquely upward when the heater 32 is not mounted on the heater holding member 33. FIG. 4B is a perspective view of the heater 32 and the heater holding member 33 as viewed obliquely upward after the heater 32 is mounted on the heater holding member 33.

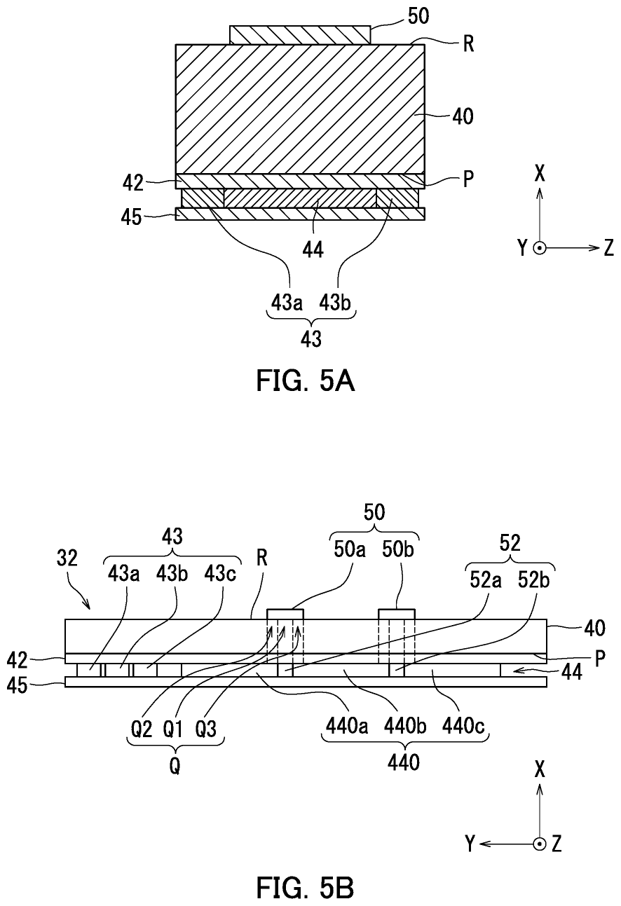

FIG. 5A is a cross-sectional view of the heater 32 of the fixing device 16 according to the present embodiment. FIG. 5B is a side view of the heater 32 of the fixing device 16 according to the present embodiment.

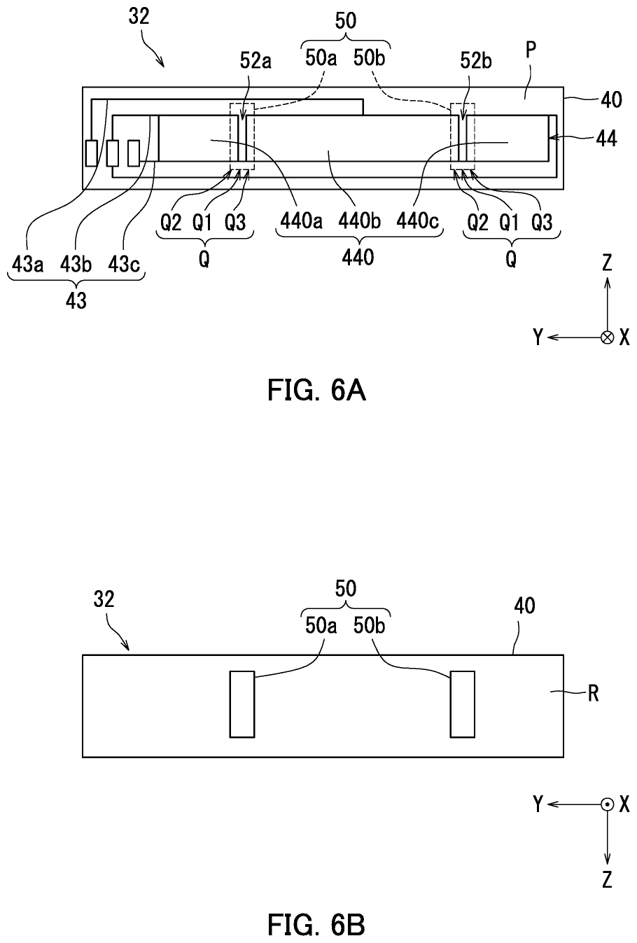

FIG. 6A is a plan view of the heater 32 of the fixing device 16 according to the present embodiment as viewed from a facing surface P of a heater substrate 40 on a side where the sheet S passes. FIG. 6B is a plan view of the heater 32 of the fixing device 16 according to the present embodiment as viewed from an opposite surface R of the heater substrate 40 opposite to the facing surface P.

As illustrated in FIG. 4A, the heater 32 extends in the main scanning direction. That is, the heater 32 has a long axis extending in the main scanning direction.

The heater 32 includes a heating element 44 on a facing surface P on a side where the sheet S passes (FIG. 1) when the sheet S passes through the fixing device 16. The heating element 44 is divided into a plurality of heating element pieces 440 (a first heating element piece 440a, a second heating element piece 440b, a third heating element piece 440c, . . . ). A gap 52a is located between the first heating element piece 440a and the second heating element piece 440b adjacent to each other. The gaps 52a insulate the heating element pieces 440 (the first heating element piece 440a, the second heating element piece 440b, the third heating element piece 440c, . . . ) from each other.

As illustrated in FIG. 4A, a user directs the facing surface P of the heater 32 in the negative X-axis direction and mounts the heater 32 on the heater holding member 33 in the positive X-axis direction.

As illustrated in FIG. 4B, the user fits the heater 32 along a heater mounting flame of the heater holding member 33.

FIG. 5A is a cross-sectional view of the heater 32 as viewed in the main scanning direction. The heater 32 includes a heater substrate 40, a glaze layer 42, a plurality of electrodes 43 (a first electrode 43a, a second electrode 43b, a third electrode 43c, . . . ), a heating element 44, an overcoat layer 45, and heat conducting members 50.

The heater 32 is disposed opposite to the inner circumferential surface of the fixing belt 30 (FIG. 3) of the fixing device 16 to heat the fixing belt 30. The heater 32 is a ceramic heater, for example.

The heater substrate 40 serves as a base of the heater 32. The heater substrate 40 is an insulating ceramic substrate with a plate shape made from for example alumina or nitride aluminum, and has a low heat capacity.

The glaze layer 42 is provided for eliminating unevenness of the facing surface P of the heater substrate 40 to facilitate arrangement of the electrodes 43 (the first electrode 43a, the second electrode 43b, the third electrode 43c, . . . ) and the heating element 44. The glaze layer 42 is layered on the facing surface P (FIG. 4A) of the heater substrate 40, and is made from a glass material such as amorphous glass. The glaze layer 42 is formed in a manner that glass paste is thick-film printed and baked. The glaze layer 42 is not an essential element in the present embodiment.

The glaze layer 42 has a heat storage property for partially storing the heat of the heating element 44, and also serves to prevent an excessive temperature increase of the heating element 44.

As illustrated in FIG. 5B, the electrodes 43 (the first electrode 43a, the second electrode 43b, the third electrode 43c, . . . ) and the heating element 44 are disposed on the facing surface P of the heater 32, which is to face the conveyed sheet S, with the glaze layer 42 therebetween.

The heating element 44 is disposed on the facing surface P of the heater substrate 40, which is to face the sheet S, with the glaze layer 42 therebetween, and includes a plurality of heating element pieces 440 arranged in a line in the main scanning direction of the sheet S at intervals of the gaps 52.

The heating element 44 generates Joule heat by electric power supplied to the heating element 44 via the electrodes 43 from a non-illustrated power source to heat the fixing belt 30 (FIG. 3). The heating element 44 is disposed on the glaze layer 42.

The heating element 44 extends in the main scanning direction. The heating element 44 has a higher resistivity than the material of the electrodes 43, and is a resistive heating element made from for example silver/palladium (Ag/Pd), ruthenium oxide (RuO₂), or tantalum nitride (Ta₂N).

For example, the heating element 44 is formed in a manner that paste of for example ruthenium oxide is thick-film printed and baked. Note that the heating element 44 may be formed by a thin film formation technique such as sputtering.

As illustrated in FIG. 6A, the electrodes 43 (the first electrode 43a, the second electrode 43b, the third electrode 43c, . . . ) energize the electric current to the respective heating element pieces 440 (the first heating element piece 440a, the second heating element piece 440b, the third heating element piece 440c, . . . ). The heating element pieces 440 adjacent to each other with the gaps 52 therebetween are connected to the mutually different electrodes 43.

As illustrated in FIGS. 5A and 5B, the overcoat layer 45 coats the electrodes 43 and the heating element 44. The overcoat layer 45 is layered on the electrodes 43 and the heating element 44.

The overcoat layer 45 is made from a glass material such as amorphous glass. The glass material has a softening point of about 700° C., for example. The overcoat layer 45 may be made in a manner that glass paste is thick-film printed and baked.

The material of the overcoat layer 45 is not limited to amorphous glass and can be any insulating material. Examples of the material thereof include silicon carbide (SiC), silicon nitride (SiN), titanium nitride (TiN), diamond-like carbon (DLC), and tetrahedral amorphous carbon (ta-C).

The overcoat layer 45 can be made to have a flat surface on a side of the heater 32 that is to face the sheet S. Accordingly, the overcoat layer 45 can make the heater 32 favorably in contact with the sheet S. Furthermore, the overcoat layer 45 having a heat dissipation property improves the heat dissipation property of the heater 32. As a result, improvement of the heat dissipation property of the heater 32 increases the printing quality on the sheet S and durability of the heating element 44.

The electrodes 43 (the first electrode 43a, the second electrode 43b, the third electrode 43c, . . . ) and the heating element pieces 440 (the first heating element piece 440a, the second heating element piece 440b, the third heating element piece 440c, . . . ) are disposed on the facing surface P of the heater substrate 40. The first electrode 43a, the second electrode 43b, the third electrode 43c, . . . are each connected to a non-illustrated power source.

In the above configuration, the printer controller 10 (FIG. 2) selects some of the heating element pieces 440 and causes the non-illustrated power source to supply electric power to only each of the selected heating element pieces 440 via corresponding one of the first electrode 43a, the second electrode 43b, the third electrode 43c, . . . .

The electrodes 43 are made from resinate Au to which rhodium, vanadium, bismuth, silicon, or the like is added as an additive element. The electrodes 43 may be formed in a manner that paste of resinate Au is thick-film printed and baked. The electrodes 43 may be formed by a thin film formation technique such as sputtering. The electrodes 43 may be composed by layering a plurality of Au layers.

As illustrated in FIG. 6A, the first electrode 43a is disposed on a side of the heating element 44 in the positive Z-axis direction, and extends in the main scanning direction in parallel to the heating element 44. The first electrode 43a is connected to the second heating element piece 440b in a conductive manner.

The second electrode 43b is disposed so as to surround the heating element 44 in the positive Z-axis direction and the negative Z-axis direction, and extends in the main scanning direction in parallel to the heating element 44. The second electrode 43b is connected to the first heating element piece 440a and the third heating element piece 440c in a conductive manner.

The third electrode 43c is disposed on a side of the heating element 44 in the negative Z-axis direction, and extends in the main scanning direction in parallel to the heating element 44. The third electrode 43c is connected to the first heating element piece 440a, the second heating element piece 440b, and the third heating element piece 440c in a conductive manner. The third electrode 43c may be a reference electrode or a ground electrode.

That is, the first heating element piece 440a is connected to the second electrode 43b in a conductive manner and the second heating element piece 440b is connected to the first electrode 43a different from the second electrode 43b in a conductive manner. Also, the second heating element piece 440b is connected to the first electrode 43a in a conductive manner and the third heating element piece 440c is connected to the second electrode 43b different from the first electrode 43a in a conductive manner.

A first gap 52a is located between the mutually adjacent first and second heating element pieces 440a and 440b. A second gap 52b is located between the second and third heating element pieces 440b and 440c. Voltages with mutually different phases may be applied to the respective mutually adjacent heating element pieces 440. As such, a potential difference may arise between the mutually adjacent heating element pieces 440 to cause a short circuit. In view of the foregoing, the gaps 52 are provided in order to insulate the mutually adjacent heating element pieces 440 from each other. Furthermore, the gaps 52 are provided in order to prevent breakage of the heater 32 due to the presence of external noise such as lighting surge.

In the present embodiment, even in a configuration in which the heating element 44 is divided into a plurality of heating element pieces 440, occurrence of a short circuit between the mutually adjacent heating element pieces 440 can be prevented through provision of the gaps 52 between the mutually adjacent heating element pieces 440.

As illustrated in FIG. 6B, the heat conducting members 50 are disposed on the opposite surface R that is located on the opposite side of the heater substrate 40 to the facing surface P.

As illustrated in FIG. 5A, the heat conducting members 50 store heat generated from the heating element 44 and radiate the heat toward the sheet S passing over the gaps 52.

In the present embodiment, as a result of the heat conducting members 50 absorbing heat from the heating element 44 and radiating the heat toward the gaps 52, temperature drop in the gaps 52 relative to the temperature of the heating element 44 can be reduced to uniform the temperature distribution across the heater 32.

As illustrated in FIG. 5B, the heat conducting members 50 (a first heat conducting member 50a and a second heat conducting member 50b) are disposed in projection areas Q in which the respective gaps 52 are projected on the opposite surface R in a direction (direction X) perpendicular to the main scanning direction and the sub-scanning direction of the sheet S.

That is, the projection areas Q each are a plane defined by a horizontal line in the main scanning direction and a horizontal line in the sub-scanning direction in a corresponding one of spaces surrounded by broken lines in FIG. 5B. Specifically, it is only required that the heat conducting members 50 (the first heat conducting member 50a and the second heat conducting member 50b) be disposed at least in projection areas Q corresponding to the respective gaps 52.

In addition, the projection areas Q may be located in any of the heater substrate 40, the glaze layer 42, the respective heating elements 44, the respective gaps 52, and the overcoat layer 45.

That is, the heat conducting members 50 (the first heat conducting member 50a and the second heat conducting member 50b) may be located in respective projection areas Q in any of the heater substrate 40, the glaze layer 42, the heating elements 44, the gaps 52, and the overcoat layer 45.

In the present embodiment, the heat generated from the heating element 44 can be radiated toward the sheet S uniformly and evenly, thereby preventing occurrence of fixing failure.

The heat conducting members 50 are each disposed so as to cross over to a second projection area Q2 and a second projection area Q3 with a first projection area Q1 therebetween. Here, the first projection area Q1 is an area in which a gap 52 is projected in the direction (X-axis direction) perpendicular to the main scanning direction and the sub-scanning direction of the sheet S, and the second projection areas Q2 and Q3 each are an area in which the mutually adjacent heating element pieces 440 (the first heating element piece 440a, the second heating element piece 440b, the third heating element piece 440c, . . . ) are projected in the direction (X-axis direction) perpendicular to the main scanning direction and the sub-scanning direction of the sheet S.

As illustrated in FIGS. 5B and 6A, the projection areas Q may each include a first projection area Q1, a second projection area Q2, and a second projection area Q3. The first projection area Q1 is an area in which a gap 52 is projected in the direction (X-axis direction) perpendicular to the main scanning direction and the sub-scanning direction. The second projection area Q2 is an area in which an end of the first heating element piece 440a located on a side of the second heating element piece 440b is projected in the direction (X-axis direction) perpendicular to the main scanning direction and the sub-scanning direction. The second projection area Q3 is an area in which an end of the second heating element piece 440b located on a side of the first heating element piece 440a is projected in the direction (X-axis direction) perpendicular to the main scanning direction and the sub-scanning direction.

The first heat conducting member 50a may be disposed so as to cover the first projection area Q1, the second projection area Q2, and the second projection area Q3. The first heat conducting member 50a may cross over the first projection area Q1 from the second projection area Q2 to the second projection area Q3.

In the present embodiment, heat generated from the heating element 44 can be radiated toward the sheet S further effectively, uniformly, and evenly, thereby preventing occurrence of fixing failure in a further favorable manner.

The first heat conducting member 50a is located in a location corresponding to the first projection area Q1, of the opposite surface R of the heater substrate 40 opposite to the facing surface P, in which the gap 52 is projected in the direction (X-axis direction) perpendicular to the main scanning direction and the sub-scanning direction of the sheet S.

That is, as illustrated in FIGS. 6A and 6B, the first heat conducting member 50a may be located in a location corresponding to the first projection area Q1 in which the first gap 52a (second gap 52b) is projected on the opposite surface R of the heater substrate 40.

Similarly, the first heat conducting member 50a may be located in a location corresponding to the second projection area Q2 in which an end of the first heating element piece 440a located on a side of the second heating element piece 440b is projected on the opposite surface R of the heater substrate 40. The first heat conducting member 50a may be located in a location corresponding to the second projection area Q3 in which the end of second heating element piece 440b located on a side of the first heating element piece 440a is projected on the opposite surface R of the heater substrate 40.

The heat conducting members 50 are disposed in the projection areas Q corresponding to the respective gaps 52 in the present embodiment. Therefore, the heat conducting members 50 can radiate heat generated from the heating element 44 toward the sheet S further effectively, uniformly, and evenly, thereby further favorably preventing fixing failure.

The heat conducting members 50 have a higher heat conductivity than the heater substrate 40. Specifically, the heat conducting members 50 may be made from any of aluminum, copper, and graphite.

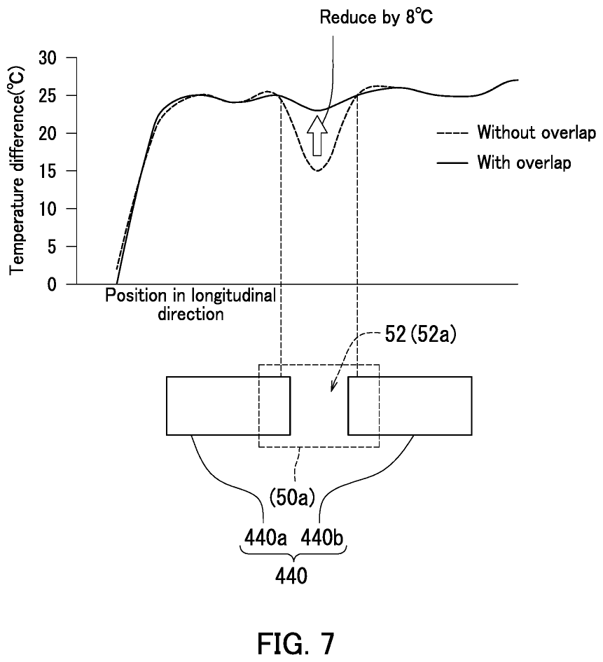

As illustrated in FIG. 7, the heat conducting members 50 absorb and store heat of the first heating element piece 440a and the second heating element piece 440b, and radiates the heat toward the first gap 52a. Accordingly, the temperature of the first gap 52a is higher by about 8° C. than that in the case in which the heat conducting members 50 are not provided. Consequently, a temperature difference between the first gap 52a and the first and second heating element pieces 440a and 440b can be reduced.

The width of the temperature distribution of the heater 32 in the main scanning direction can be reduced in the present embodiment. In other words, the temperature distribution of the heater 32 in the main scanning direction can be flattened (smoothed).

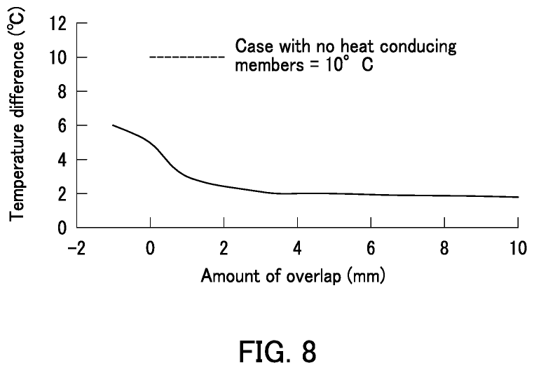

The temperature distribution of the heater 32 in the main scanning direction will be described next with reference to FIG. 8. FIG. 8 is a digraph representation showing a relationship between the amount of overlap and the temperature difference. Here, the amount of overlap is an amount of overlap between heating element pieces 440 and a corresponding heat conducting member 50 of the heater 32 of the fixing device 16 according to the present embodiment and the temperature difference is a temperature difference between a gap 52 and corresponding heating element pieces 440.

The heat conducting members 50 overlap by at least 4 mm in the main scanning direction of the sheet S with the corresponding projection areas Q, on the opposite surface R, of the heater substrate 40 opposite to the facing surface P, to which the heating element pieces 440 are projected in the direction (X-axis direction) perpendicular to the main scanning direction and the sub-scanning direction of the sheet S.

Specifically, the heat conducting member 50a preferably overlaps by at least 2 mm with the first heating element piece 440a as illustrated in FIG. 7. Also, the heat conducting member 50a preferably overlaps by at least 2 mm with the second heating element piece 440b.

That is, as a result of the heat conducting members 50 overlapping with the first heating element piece 440a and the second heating element piece 440b by 4 mm in total, the temperature difference between the heating element pieces 440a and 440b and the gaps 52a can be reduced by 2° C. or less.

In the present embodiment, as a result of the heat conducting members 50 and the heating element pieces 440 being disposed so as to overlap with each other, the width of the temperature distribution of the heater 32 in the main scanning direction can be favorably reduced. Furthermore, the temperature distribution of the heater 32 in the main scanning direction can be further favorably flattened (smoothed).

An embodiment of the present disclosure has been described so far with reference to the drawings. However, the present disclosure is not limited to the above embodiment and may be implemented in various different forms that do not deviate from the essence of the present disclosure. The drawings schematically illustrate elements of configuration in order to facilitate understanding, and properties of elements of configuration illustrated in the drawings, such as thickness, length, and number thereof, may differ from actual properties thereof in order to facilitate preparation of the drawings. Furthermore, properties of elements of configuration described in the above embodiment, such as material, shape, and dimensions, are merely examples and are not intended as specific limitations. Various alterations may be made so long as there is no substantial deviation from the effects of the present disclosure.

What is claimed is:

1. A fixing device comprising a heater that heats a toner image transferred to a sheet for fixing the toner image to the sheet, wherein
the heater includes:
a heater substrate having a facing surface that is to face the sheet and an opposite surface opposite to the facing surface;
a heating element disposed on the facing surface of the heater substrate and including a plurality of heating element pieces arranged in a line in a main scanning direction of the sheet with a gap therebetween; and
a heat conducting member configured to store heat generated from the heating element and radiate the heat toward the sheet passing over the gap.

2. The fixing device according to claim 1, further comprising
a plurality of electrodes configured to energize an electric current to the respective heating element pieces, wherein
mutually adjacent heating element pieces of the heating element pieces that are adjacent to each other with the gap therebetween are connected to mutually different electrodes of the electrodes.

3. The fixing device according to claim 1, wherein
the heat conducting member is disposed in a projection area in which the gap is projected in a direction perpendicular to the main scanning direction and a sub-scanning direction of the sheet.

4. The fixing device according to claim 1, wherein
the heat conducting member crosses over to both of second projection areas with a first projection area therebetween, the first projection area being an area in which the gap is projected in a direction perpendicular to the main scanning direction and a sub-scanning direction of the sheet, the second projection areas being areas in which the respective mutually adjacent heating element pieces are projected in the direction perpendicular to the main scanning direction and the sub-scanning direction of the sheet.

5. The fixing device according to claim 1, wherein
the heat conducting member is located in a location corresponding to a first projection area, of the opposite surface of the heater substrate, in which the gap is projected in a direction perpendicular to the main scanning direction and a sub-scanning direction of the sheet.

6. The fixing device according to claim 1, wherein
the heat conducting member has a higher heat conductivity than the heater substrate.

7. The fixing device according to claim 1, wherein
the heat conducting member is made from any of aluminum, copper, and graphite.

8. The fixing device according to claim 1, wherein
the heat conducting member overlaps by at least 4 mm in the main scanning direction of the sheet with projection areas, of the opposite surface of the heater substrate, in which the respective heating element pieces are projected in a direction perpendicular to the main scanning direction and a sub-scanning direction of the sheet.

9. An image forming apparatus comprising
the fixing device according to claim 1.
